(19) United States
(12) Patent Application Publication
(10) Pub. No.: US 2009/0065169 A1
(43) Pub. Date: Mar. 12, 2009

(54) TECHNIQUE FOR FORMING TITANIUM ALLOY TUBES

(75) Inventor: CHUNG CHING CHI, Pingtung County (TW)

Correspondence Address: APEX JURIS, PLLC, 12733 LAKE CITY WAY NORTHEAST, SEATTLE, WA, 98125, US

(73) Assignee: T.K TECHNOLOGY CO., LTD, Pingtung County (TW)

(21) Appl. No.: 11/853,073

(22) Filed: Sep. 11, 2007

(51) Int. Cl. B23K 31/02; B22D 27/00

(52) U.S. Cl. 164/68.1

(57) ABSTRACT

A technique for forming titanium alloy tubes mainly includes the steps of: delivering a titanium alloy wire into a upper end of a forming barrel which houses a stem and a holding dock at the top end that are rotatable and movable up and down in a helical manner; inserting a welding gun into the upper end of the forming barrel; melting the titanium alloy wire to become titanium alloy liquid resulting from interactions between the welding gun and the titanium alloy wire under a high temperature released by the welding gun; dropping the titanium alloy liquid onto a holding tube molten trough 15 located at a upper end surface of the holding dock; and stacking repeatedly the titanium alloy liquid on the rotating and downward moving stem in an environment containing inertial gases with less than 6% of hydrogen gas to gradually form a hollow tube.

### BACKGROUND OF THE INVENTION

1. Field of the Invention

The present invention relates to a technique for cast-welding titanium alloy tubes and particularly to a cast-welding method to form a hollow tube by melting a titanium alloy wire to become a liquid state through arc welding in a protected environment of a lower temperature containing inertial gases with less than 6% of hydrogen gas and rotating in a helical manner such that the tube is formed in an equiaxial structure with fine crystals.

2. Description of the Prior Art

Casting is a method that pours molten metal liquid in a casting mold and treats the metal liquid by vacuuming, centrifuging or die casting to become a casting piece of a selected shape after the metal liquid is condensed. Welding is another method that uses a heat source such as flame, electric resistance or arc to melt two abutting metals to form a bonding relationship. Casting and welding are different fabrication techniques. This invention focuses on forming a hollow tube, especially a hollow tube made of a titanium alloy by casting or welding. On casting, the molten metal liquid is compressed through a casting mold to extrude a hollow tube at a selected diameter. On welding, a metal sheet is formed in a tubular shape by a calender through a rolling and extrusion process, then two abutting ends of the tubular metal sheet are welded together to become a finished hollow tube. The finished product quality (strength, toughness, rust and corrosion resistance) of the hollow tube fabricated by either of the two methods set forth above still has room for improvement. Thus techniques to fabricate hollow tubes through titanium or titanium alloys have been developed. The titanium alloys have desirable mechanical characteristics such as rust-resistant, light weight and greater strength, and an excellent strength. Titanium is a metal with a great application potential. However, when titanium goes through casting process or the titanium alloys are condensed and crystallized, the crystals grow at a speed faster than the growth speed of the crystal nucleus. As a result, the casting product of titanium has coarser crystal granules. The tensile strength and fatigue resistance are lower. To remedy the problems of the titanium or titanium alloy casting or welding products that have a coarser structure and poorer product quality, the conventional products formed by casting or welding have to go through a heat treatment process to improve the arrangement of metal molecules to achieve a better material quality. The general approach in the industry to enhance the mechanical characteristics of the material is heat treatment, especially annealing. However, heat transfer rate and coefficient of titanium or titanium alloys are lower. A greater temperature difference occurs to the fabricated product during heating and cooling processes of the heat treatment. As a result, the fabricated product has a greater residual stress and results in product defects such as deformation or cracks. Moreover, titanium or titanium alloys easily absorb hydrogen during heat treatment. When the hydrogen content reaches a certain degree, the resulting fabricated product suffers from hydrogen brittleness.

### SUMMARY OF THE INVENTION

In view of the aforesaid problems, the present invention aims to provide a cast-welding fabrication method which incorporates casting and welding techniques to fabricate titanium alloy tubes based on a titanium alloy wire to get an improved structure which is equiaxial and consists of fine crystals. The structure thus formed has an improved quality such as a greater tensile strength and fatigue resistance.

Therefore it is an object of the invention to improve the problems and shortcomings occurred to the conventional hollow tubes by providing a cast-welding method to melt a titanium alloy wire by arc in an environment of a lower temperature that contains inertial gases with less than 6% of hydrogen gas and stack the liquid state titanium alloy in a helical manner to form a hollow tube in an equiaxial structure consisting of fine crystals to achieve a higher quality.

The foregoing, as well as additional objects, features and advantages of the invention will be more readily apparent from the following detailed description, which proceeds with reference to the accompanying drawings.

### BRIEF DESCRIPTION OF THE DRAWINGS

The above and other objects of the present invention will become readily apparent by reference to the following detailed description when considered in conjunction with the accompanying drawings wherein:

FIG. 1 is a schematic view of the invention showing a forming process.

FIG. 2 is a schematic view of the invention showing another forming process.

FIG. 3 is a schematic view of an embodiment of the invention.

### DESCRIPTION OF THE PREFERRED EMBODIMENTS

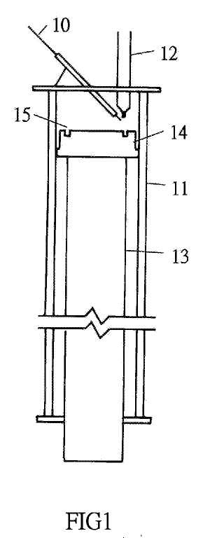

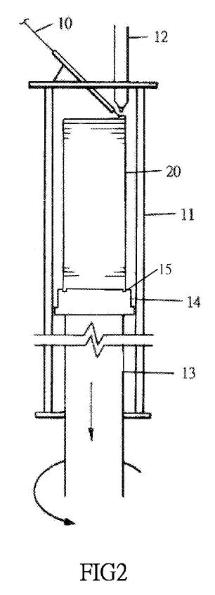

Referring to FIGS. 1 and 2, according to the technique of the invention a titanium alloy wire 10 is delivered to a upper end of a forming barrel 11. There is a plasma arc welding gun 12 inserted into the upper end of the forming barrel 11 to generate a reaction with the titanium alloy wire 10 which is melted under the high temperature of arc produced by the welding gun 12 to become titanium alloy liquid. In the forming barrel 11 there is also a stem 13 which may be rotated and moved up and down under control. The stem 13 has a top end fastened to a holding dock 14. The holding dock 14 has a upper end surface with an annular molten trough 15 formed thereon to hold and discharge liquid. Inertial gases (such as helium gas, argon gas and the like) are injected into the forming barrel 11. Under the protection of the inertial gases crystallized phenomenon can be prevented from taking place at the welding locations of the titanium alloy at the high temperature. Hence the characteristics of extensibility, corrosion resistance and the like can be maintained. The forming barrel 11 is maintained at a lower temperature. Water cooling may be adopted to accomplish this objective by circulating water of 15° C.-25° C. through the wall of the forming barrel 11 to keep the forming barrel 11 and the interior thereof at a lower temperature.

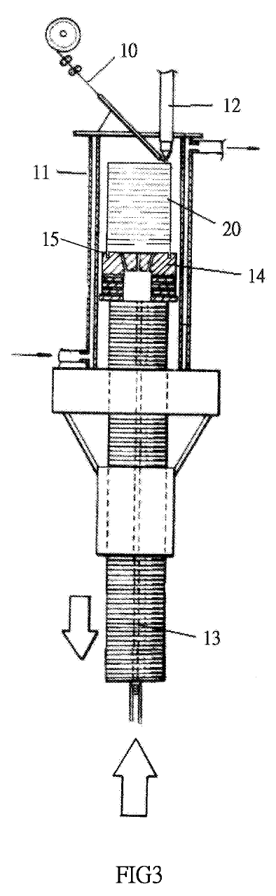

When the titanium alloy wire 10 is delivered into the forming barrel 11, it is melted by the arc. The liquid alloy drops to the upper side of the molten trough 15 of the holding dock 14 at the top end of the stem 13. As the titanium alloy liquid has a lower fluidity and the stem 13 is rotated and moved down in a helical manner, under the protection of an environment which contains the inertial gases and is at a lower temperature, the titanium alloy liquid gradually stacks to form a hollow tube 20 (as shown in FIG. 3). As the temperature of the forming barrel 11 and the interior is lower due to water cooling, and the holding dock 14 may be fabricated from a material of a desired heat transfer characteristics (such as copper), the holding dock 14 can hold the high temperature titanium alloy liquid without damaging the molecules on the surface of the holding dock 14. Moreover, while the high temperature titanium alloy liquid repeatedly stacks to form the tube 20, the newly added high temperature titanium alloy liquid produces an annealing effect to the lower and condensed tube so that the metal structure is more stable, and residual stress can be reduced and material extensibility can be enhanced.

Furthermore, in the forming barrel 11, aside from injecting the inertial gases to protect the high temperature titanium alloy liquid from crystallizing, less that 6% of hydrogen gas may also be added to the inertial gases. The hydrogen is a strong β phase stable element for the titanium alloy, and can significantly lower the β transformation temperature of Ti-6Al-4V alloy (64 Titanium), and generate an eutectoid reaction. Moreover, the titanium alloy treated with hydrogen can be thermally formed easier. The phase structure of the titanium alloy also is affected. The flake type coarser crystals are transformed to a spherical and finer structure. Hence the tensile strength and fatigue resistance of the titanium alloy are enhanced. As the interaction of the hydrogen in the titanium alloy is reversible, and the hydrogen is permeable in the titanium alloy at the high temperature, the hydrogen may be removed in vacuum (vacuum annealing) to reduce the hydrogen content in the titanium alloy product below an allowable value to obtain an equiaxial structure with finer crystals. In addition, when the titanium alloy wire 11 is delivered in the forming barrel 11 and melted by the arc to drop to the molten trough 15 of the holding dock 14, the stem 13 is rotated and moved down in the helical manner to allow the titanium alloy liquid to stack repeatedly to gradually form the tube 20. The titanium alloy of the tube 20 formed by stacking is cooling down gradually at the melting temperature, thus a low temperature eutectoid reaction takes places, and a high quality tube can be formed.

As a conclusion, the tube 20 of the invention if formed by melting the titanium alloy wire 10 through arc to become titanium alloy liquid to form a coupling relationship of two abutting metals by welding. And the metal liquid is condensed to form a selected shape. Such a method incorporates the two main fabrication methods of casting and welding. Thus it is named cast-welding.

By means of the technique previously discussed, a high quality titanium alloy tube can be fabricated. The finished product can be widely used in various types of industries and products. It is a significant improvement over the conventional techniques.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

I claim:

1. A technique for forming titanium alloy tubes by cast-welding, comprising the steps of:
delivering a titanium alloy wire into a upper end of a forming barrel which contains inertial gases and hydrogen gas by injection and is maintained at a lower temperature and houses a stem rotatable and movable up and down in a helical manner that has a top end fastened to a holding dock;
inserting a welding gun into the upper end of the forming barrel;
generating interactions between the welding gun and the titanium alloy wire such that the titanium alloy wire is melted to become titanium alloy liquid under a high temperature released by the welding gun;
dropping the titanium alloy liquid to a upper side of the holding dock; and
stacking the titanium alloy liquid repeatedly on the rotating and downward moving stem in an environment of the lower temperature contained the inertial gases to gradually form a hollow tube.

2. The technique for forming titanium alloy tubes of claim 1, wherein the hydrogen gas injected in the forming barrel is less than 6% of the total injected gases amount.
